(19) United States
(12) Patent Application Publication
(10) Pub. No.: US 2005/0205514 A1
(43) Pub. Date: Sep. 22, 2005

(54) Optical microelectromechanical component and fabrication method thereof

(75) Inventors: Mingching Wu, Yingge Township (TW); Hung-Yi Lin, Hsinchu City (TW); Weileun Fang, Hsinchu City (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Walsin Lihwa Corp., Taipei (TW)

(21) Appl. No.: 10/933,630

(22) Filed: Sep. 3, 2004

(30) Foreign Application Priority Data
Mar. 19, 2004 (TW) 093107583

(51) Int. Cl. B44C 1/22; C23F 1/00

(52) U.S. Cl. 216/2; 216/83; 216/17; 216/18

(57) ABSTRACT

The optical microelectromechanical components and the fabrication method thereof are provided. The method for fabricating an optical microelectromechanical component includes steps of (a) providing a substrate; (b) depositing an oxide layer on the substrate as a first mask; (c) performing a plurality of first etchings on the substrate to form a plurality of trenches with a plurality of depths; (d) depositing a first polysilicon layer on the trenches to form refilled trenches.

### FIELD OF THE INVENTION

This invention relates to an optical microelectromechanical component and a method for fabricating the optical microelectromechanical component, and more particularly to an microelectromechanical component fabricated by integration of the DRIE, MUMPs and the bulk micromachining.

### BACKGROUND OF THE INVENTION

Semiconductor processing methods and micromachining methods are integrated for fabricating optical microelectromechanical components on a chip so as to form a microelectromechanical system (MEMS). Nowadays, the optical MEMS is an emerging field, wherein the poly-Si MUMPs process is regarded as the most important platform technology for micro-optical devices. However, the applications of surface micromachined devices are limited to the stiffness and residual stresses of thin films. (L.-Y. Lin, E. L. Goldstein, and R. W. Tkach, “On the expandability of free-space micromachined optical cross connects,” Journal of lightwave technology, vol. 18, pp. 482-488, 2000.) For example, when the polysilicon thin film fabricated by the conventional thin film processing is applied in the optical devices, the polisilicon thin film easily becomes deformed.

In addition, electrical interconnection is a key challenge in micro-optical devices because of the lack of isolation layer. When the silicon rich nitride and special mechanical design are employed to improve the micro-optical device, the device also suffers from the electrical routing problem since SiₓN_{y} is a dielectric material. (H.-Y. Lin, H.-H. Hu, W. Fang, and R.-S. Huang, “High resolution micromachined scanning mirror,” Transducer '01, Munich, Germany, Jun. 10-14, pp. 1310-1313, 2001.)

In order to overcome the disadvantages of the prior art described above, the present invention provides a method integrating DRIE, MUMPs and the bulk micromachining to fabricate an optical microelectromechanical component including the undeformable polysilicon film with characteristics of a thin film.

### SUMMARY OF THE INVENTION

It is an aspect of the present invention to provide a method integrating DRIE, MUMPs and micromachining for fabricating an optical microelectromechanical component so as to improve the conventional thin film processing. The method of the present invention for fabricating an optical microelectromechanical component includes steps of: (a) providing a substrate; (b) depositing an oxide layer on the substrate as a first mask; (c) performing a plurality of first etchings on the substrate to form a plurality of trenches with a plurality of depths; (d) depositing a first polysilicon layer on the trenches to form refilled trenches.

Preferably, the substrate is a silicon substrate.

Preferably, the plurality of first etchings are first deep reactive ion etchings.

Preferably, the plurality of first etchings are two first etchings.

Preferably, the first polysilicon layer is removed by a second deep reactive ion etching.

In accordance with the present invention, the method further includes steps of: (e) depositing a first nitride layer and a second polysilicon layer on the refilled trenches; (f) removing the first polysilicon layer; (g) depositing a second nitride layer; and (h) performing a second etching.

In accordance with the present invention, the method further includes a step of (e1) patterning the first nitride layer and the second polysilicon layer to form an electrical connection.

Preferably, the first nitride layer is a SixNy layer.

Preferably, the oxide layer and the second nitride layer are performed as passivation layers.

Preferably, the second nitride layer is a SixNy layer.

In accordance with the present invention, the method further includes a step of (g1) removing the oxide layer and the second nitride layer.

Preferably, the oxide layer and the second nitride are removed by a hydrogen fluoride solution.

Preferably, the second etching is a bulk etching.

Preferably, the second nitride layer is a second mask for the bulk etching.

Preferably, the bulk etching is performed in a tetra-methyl ammonium hydroxide (TMAH) solution.

It is another aspect of the present invention to provide a method integrating DRIE, MUMPs and micromachining for fabricating an optical microelectromechanical component so as to improve the conventional thin film processing. The method of the present invention for fabricating an optical microelectromechanical component includes steps of: (a) providing a substrate; (b) perfoming a first etching on the substrate to form at least one trench; (c) depositing a polysilicon layer on the trench to form a refilled trench; (d) depositing a nitride layer on the refilled trench; and (e) performing a second etching.

In accordance with the present invention, the method further includes a step of (a1) depositing an oxide layer on the substrate as a self-aligned etching mask.

It is another aspect of the present invention to provide an optical microelectromechanical component fabricated by the method of the present invention. The optical microelectromechanical component includes a polysilicon thin film substrate; and a rib structure for strengthening the optical microelectromechanical component.

In accordance with the present invention, the optical microelectromechanical component further includes a torsional element for lowering a driving voltage and a plurality of electrodes with a plurality of depths.

Preferably, the optical microelectromechanical component is an optical scanner.

The above aspects and advantages of the present invention will become more readily apparent to those ordinarily skilled in the art after reviewing the following detailed description and accompanying drawings, in which:

### BRIEF DESCRIPTION OF THE DRAWINGS

FIGS. 1(A)-1(H) are schematic views illustrating the fabrication method of an optical microelectromechanicel component according to the present invention;

FIG. 2 is an electron microscopic view showing an one-axis optical scanning mirror fabricated by the method of the present invention;

FIG. 3 is an electron microscopic view showing a two-axis optical scanning mirror fabricated by the method of the present invention;

FIGS. 4(A)-4(B) are SEM images respectively showing a portion of the optical scanning mirror fabricated by the method of the present invention;

FIGS. 5(A)-5(B) are SEM images showing a cross section view of vertical comb electrodes according to the embodiment of the present invention;

FIG. 6(A)-6(B) are SEM images showing the perfect self-alignment of the vertical comb electrodes according to the embodiment of the present mvention;

FIG. 7 is a chart showing the angular motion of the one-axis optical scanning mirror fabricated by the method of the present invention;

FIG. 8 is a chart showing the variation of the driving voltage and the angular displacement of the one-axis optical scanning mirror fabricated by the method of the present invention;

FIG. 9 is a chart showing the frequency response of one-axis optical scanning mirror driven by the vertical comb actuators according to the embodiment of the present invention; and

FIG. 10 is a chart showing the dynamic response of the two-axis optical scanning mirror driven by a PZT actuator according to the embodiment of the present invention.

### DETAILED DESCRIPTION OF THE PREFERRED EMBODIMENT

The invention is described more specifically with reference to the following embodiments. It is to be noted that the following descriptions of preferred embodiments of this invention are presented herein for the purpose of illustration and description only; it is not intended to be exhaustive or to be limited to the precise form disclosed.

The present invention has been published on IEEE International Conference on MEMS 2004, Maastricht, Netherlan-ds, Jan. 25-29, pp. 97-100, 2004, and entitled “Integration of the DRIE, MUMPs, and Bulk Micromachining for Superior Micro-Optical Systems”.

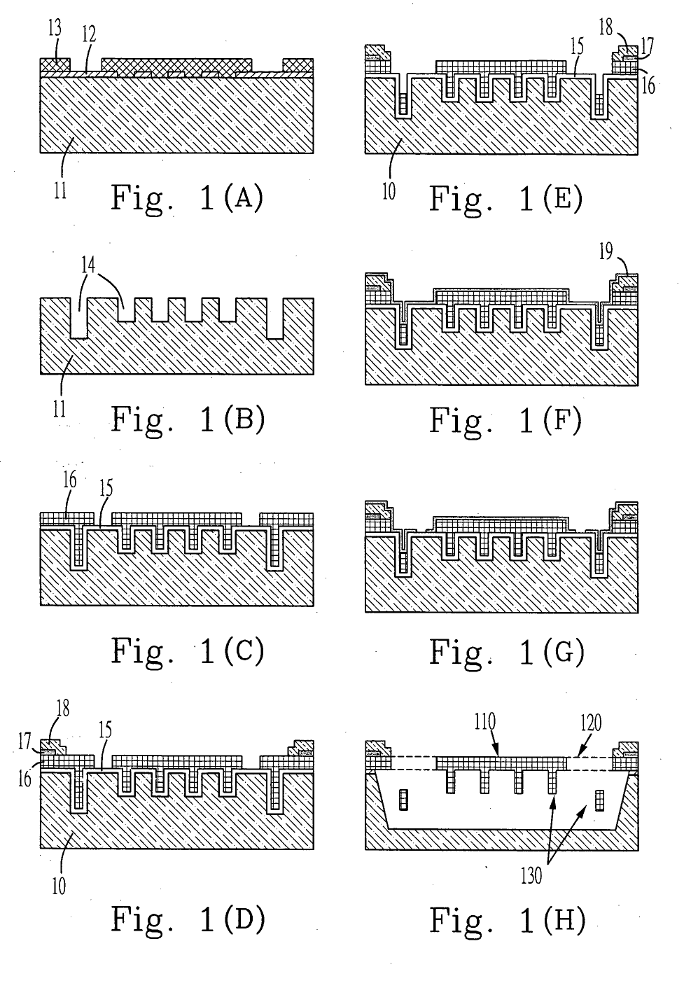

The present invention provides a method integrating DRIE, MUMPs and micromachining for fabricating an optical microelectromechanical component so as to improve the conventional thin film processing. Please refer to FIGS. 1(A)-1(H) illustrating the fabrication method of an optical microelectromechanicel component. The silicon thin film is used as a substrate 11, and then an oxide layer 12 and a photoresist 13 are deposited as self-aligned etching masks as shown in FIG. 1(A). Referring to FIG. 1(B), the trenches 14 with two different depths are formed on the substrate 11 by performing two different DRIEs (Deep Reactive Ion Etching, DRIE) so as to form vertical comb electrodes. Referring to FIG. 1(C), a thermal oxide layer 15 formed by the thermal oxidation and a first polysilicon layer 16 are deposited on the trenches 14 to refill the trenches 14 so as to form a rib reinforced structure. Consequently, the stiffness of the thin film structure is increased by the rib reinforced structure. Referring to FIG. 1(D), a first nitride layer 17 and a second polysilicon layer 18 are deposited on the refilled trenches, wherein the nitride layer 17 is preferred as a SiₓN_{y} layer. Then, the nitride layer 17 and the second polysilicon layer 18 are patterned to form an electrical connection. Referring to FIG. 1(E), portions of the first polysilicon layer 16 are removed by a DRIE so as to trim the depths of the comb electrodes. Referring to FIGS. 1(F) and 1(G), a second nitride layer 19 with a low stress is deposited and then patterned as an etching mask for a bulk etching. Then, the whole substrate structure is immersed into TMAH (tetra-methyl ammonium hydroxide) solution for the bulk etching, wherein the thermal oxide layer 15 and the second nitride layer 19 are performed as passivation layers. Finally, the passivation layers are removed by HF so as to obtain an optical microelectromechanical component as shown in FIG. 1(H). Referring to FIG. 1(H), the numeral 110 indicates a scanning mirror with the rib reinforced structure, the numeral 120 indicates a torsional bar, and the numeral 130 indicates vertical comb electrodes.

According to the present invention, the step of refilling the trenches 14 is the most critical. It is very important that the substrate is etched to form deep trenches before thin film deposition, and then the trenches are refilled to form a U-shaped structure after the thin film deposition. Hence, the shape of the structure is changed without increasing the thickness of the structure. According to our finding, two thin film components having the same thicknesses and sizes have different stiffness when one thin film component has rib reinforced structures but the other thin film component has no rib reinforced structures. The stiffness of the thin film component having rib reinforced structures is 100-fold higher than that of the thin film having no rib reinforced structures. Furthermore, the stiffness enforcement is better if the trenches are deeper. Accordingly, the weak stiffness of the conventional thin film mirror is overcome.

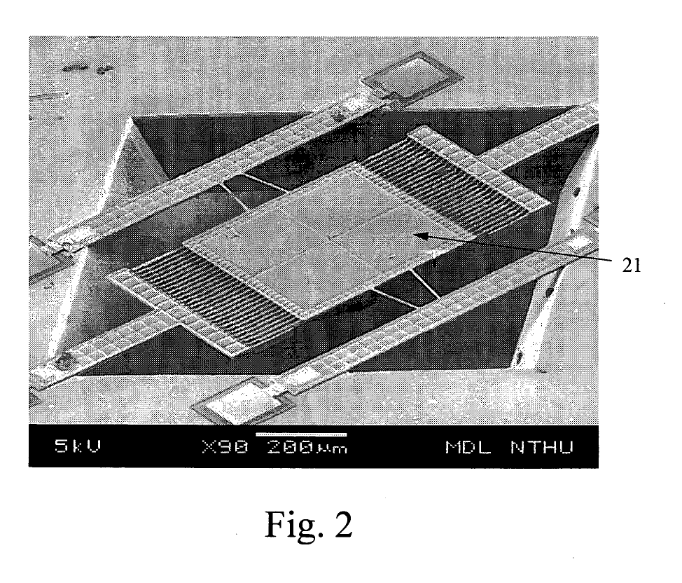

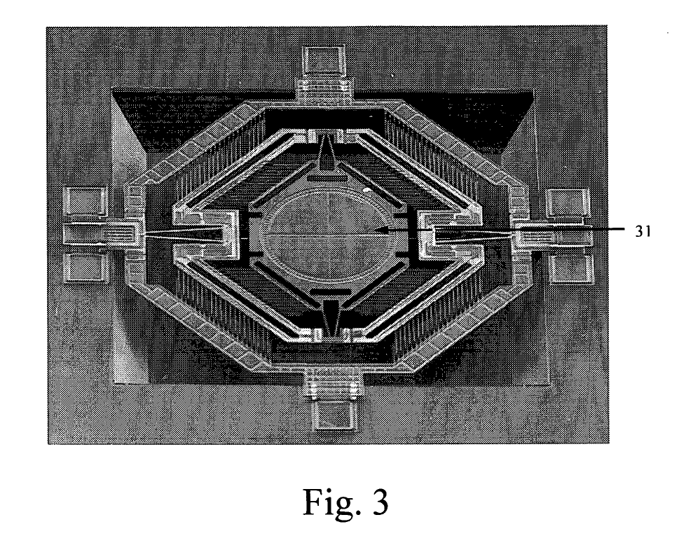

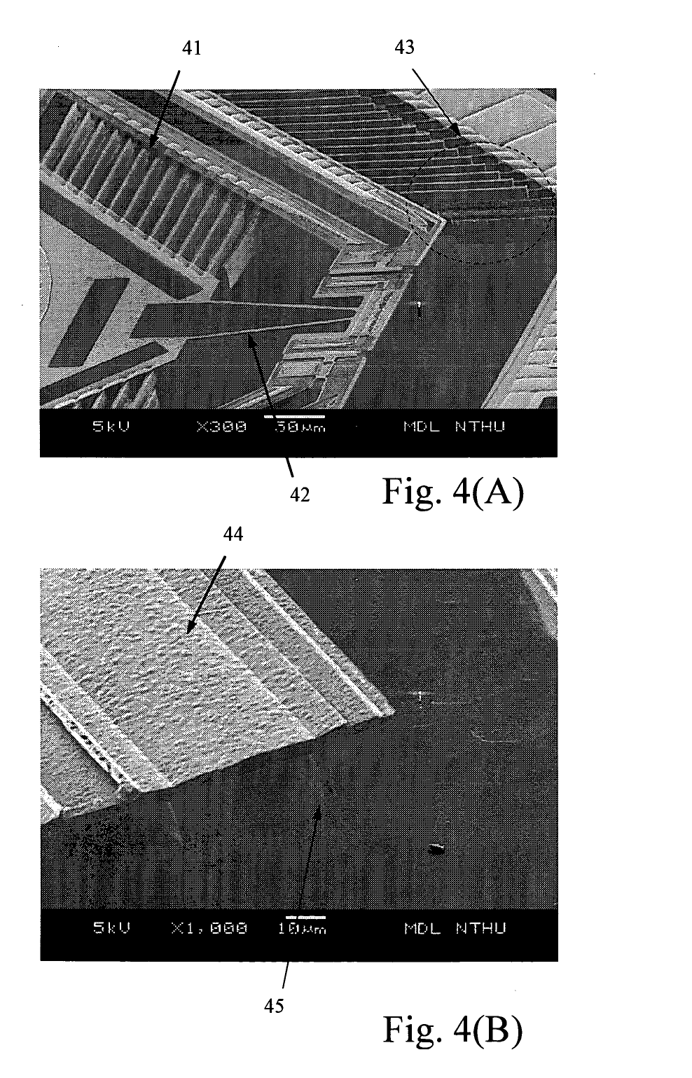

Please refer to FIGS. 2 and 3 respectively showing one-axis optical scanning mirror and two-axis optical scanning mirror fabricated by the method of the present invention. The portions of the optical scanning mirror fabricated by the method of the present invention are shown in FIGS. 4(A) and 4(B). Referring to FIGS. 2-4(B), the optical scanning mirror includes vertical comb electrodes 41, a torsional bar 42, a mirror plate 21 or 31, electrodes 43 with multiple depths, a frame 44 and rib reinforced structures 45. The multiple depths are respective 20 micrometers and 40 micrometers as shown in FIG. 4(A). Since the optical scanning mirror is formed by the thin film with a thickness of 2 micrometers, the torsional bar 42 is easily to be twisted. Furthermore, the mirror plate and the frame 44 are reinforced by the rib reinforced structure 45 with a thickness of 20 micrometers. Hence, the stiffness of these structures is significantly increased.

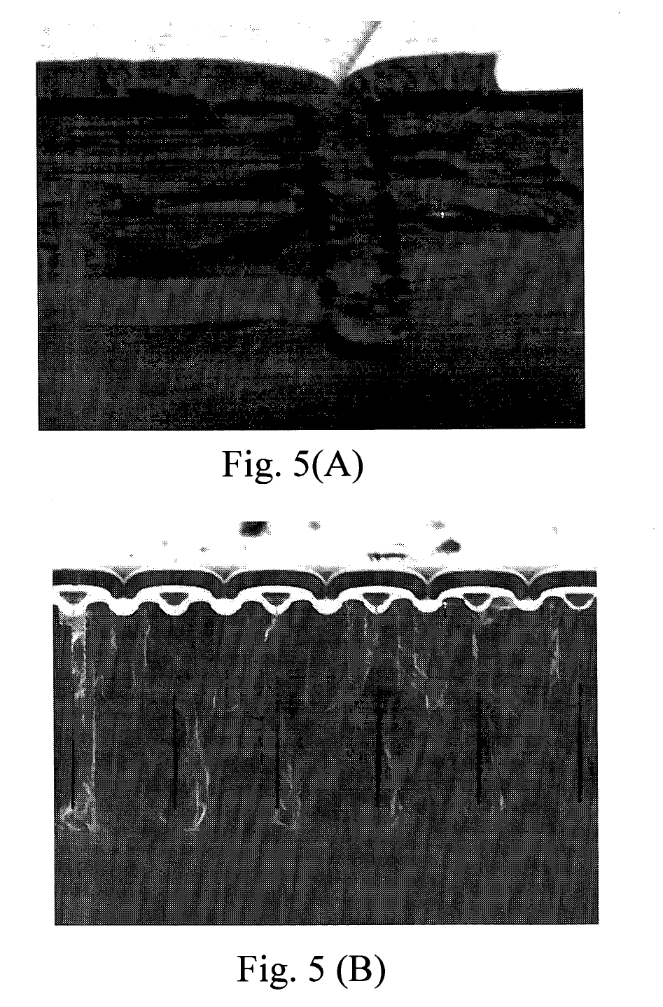

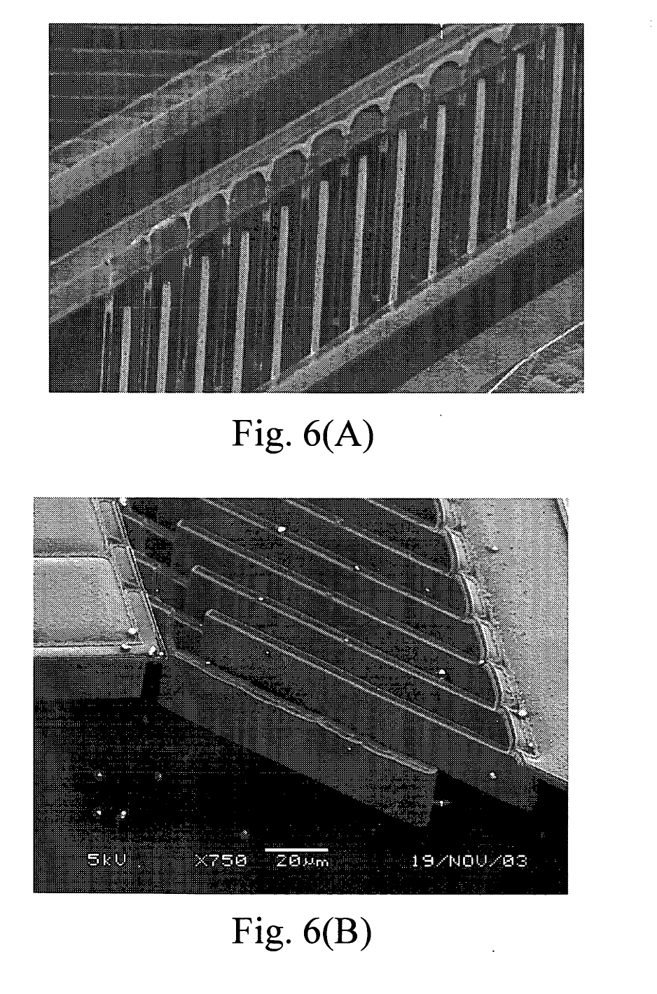

In accordance with the present invention, the opening of the trench is about 4 micrometers. Please refer to FIGS. 5(A) and 5(B) showing the cross section views of the vertical comb electrodes right after the step of refilling the trenches. The shallow trenches with 20 micrometers in depth are fully filled as shown in FIG. 5(A), whereas the deep trenches with 40 micrometers in depth exist void. Please refer to FIGS. 6(A) and 6(B) respectively showing the top view and the side view of the self-aligned vertical comb electrodes after bulk etching. It is obtained that the vertical comb electrodes, made by multi-depth DRIE etchings and trench-filled polysilicon process, were self-aligned perfectly. In order to demonstrate the performance of the optical microelectromechanical component fabricated by the method of the present invention, the static and dynamic characteristics of the optical microelectromechanical component are further examined.

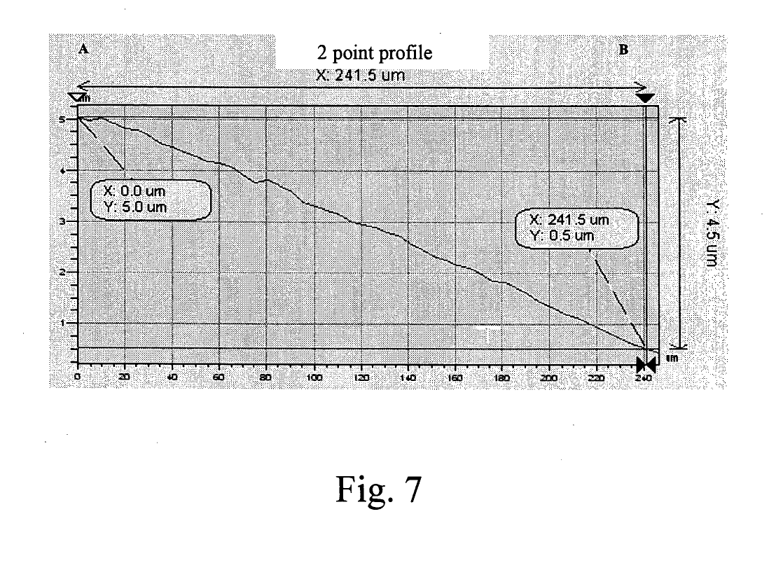

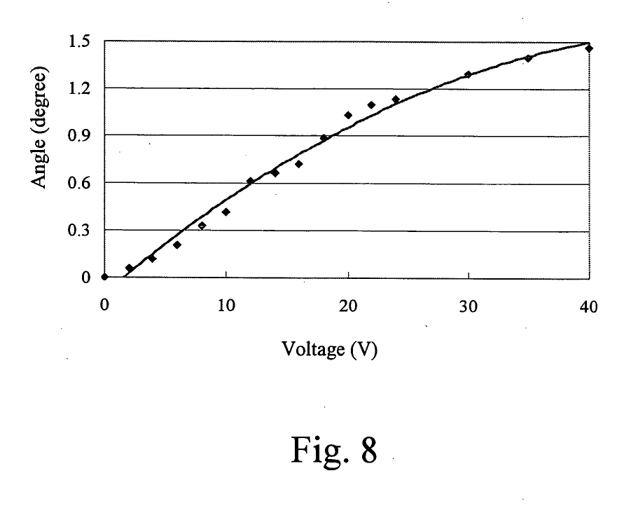

The one-axis optical scanning mirror 21 as shown in FIG. 2 is driven by DC voltage, and then the static load-deflection performance of the one-axis optical scanning mirror is measured. The out-of-plane angular displacement of the one-axis optical scanning mirror was measured by the optical interferometer and the results are shown in FIG. 7. The variation of the driving voltage and the angular displacement for DC operation is shown in FIG. 8. Referring to FIG. 8, the one-axis optical scanning mirror has a maximum scanning angle, 1.5 degree, at 40 V. It means that when the driving voltage exceeds 40 V, the instability of vertical comb actuator due to side-sticking effect occurs. Accordingly, the out-of-plane displacement of vertical comb actuator is limited to only 6.4 micrometers although the maximum allowable traveling distance for this design is 20 micrometers. It is possible to overcome the instability of electrodes using the V-shaped torsional bar, so that the scanning angle can be increased.

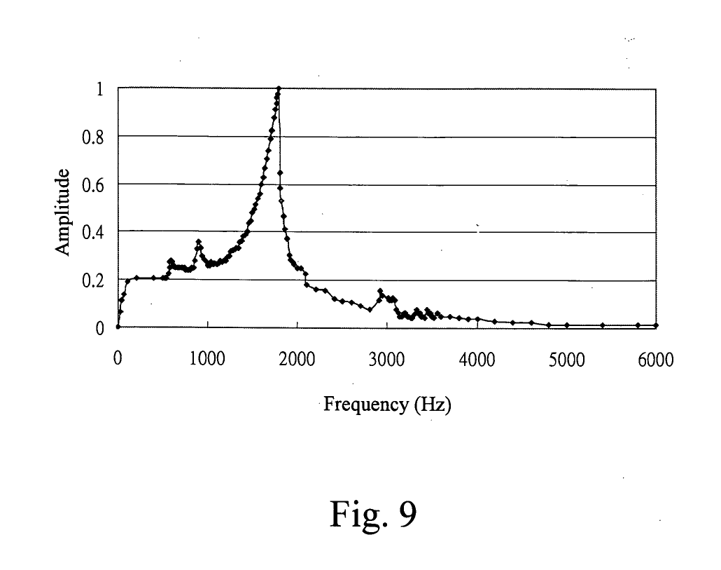

Furthermore, the one-axis optical scanning mirror as shown in FIG. 2 was driven by vertical comb actuator using AC voltages (4-V peak-to-peak), and then measured by the Laser Doppler Vibronieter, so that the dynamic response of the one-axis optical scanning mirror is obtained and shown in FIG. 9. Referring to FIG. 9, the resonant frequency of the one-axis optical scanning mirror is 1.8 kHz. It means that the one-axis optical scanning mirror will not be influenced by environment disturbances because its resonance frequency is higher than 1 kHz.

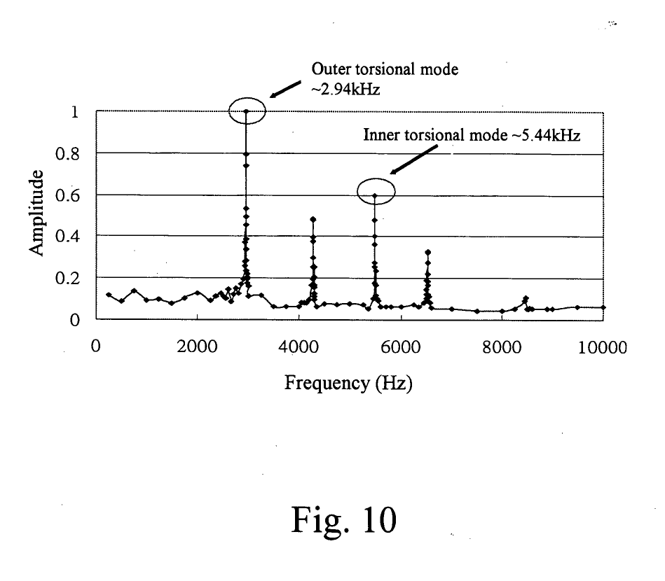

The dynamic characteristics of the two-axis optical scanning mirror provided by the present invention are also measured. The two-axis optical scanning mirror was placed in a vacuum chamber and then excited by a PZT actuator. The dynamic responses of the two-axis optical scanning mirror are shown in FIG. 10. Referring to FIG. 10, the resonance of outer torsional mode is 2.94 kHz and the inner torsional mode is 5.44 kHz.

According to the present invention, the multi-depth DRIE etchings, MUMPs and the bulk etching are integrated to fabricate superior polysilicon optical microelectromechanical components. The optical scanning mirrors driven by vertical comb actuators as shown in the present invention can be fabricated by the method of the present invention. The characteristic lengths of these optical microelectromechanical components in the film thickness direction are ranging from about 1 micrometers to about 100 micrometers. For instance, the thin-film torsional bar (about 2 micrometers) is designed to be flexible enough.

According to the present invention, the high aspect ratio is achieved by the step of refilling trenches, so that the thin film structure is thickened and still flexible. It is to be noted that in the prior art, the residual stress on the thin film resulted in the static deformation of the polysilicon mirror plate, and furthermore the intrinsic stress of the thin film resulted in the dynamic deformation of the polysilicon mirror plate. However, the rib reinforced structures are formed on the optical scanning mirror of the present invention to increase the optical scanning mirror stroke and structure stiffness. Furthermore, according to the present invention, the bulk etching creates a cavity (more than 100 micrometer) i.e. a space for the motion of the scanning mirror. In addition, these polysilicon optical microelectromechanical components provided by the present inveniton can be further integrated with the MUMPs devices to establish a more powerful MOEMS platform.

According to the present invention, the optical scanning mirrors are driven by vertical comb actuators, and the mirror plate of the optical scanning mirror can perform out-of-plane motions.

According to the present invention, the advantages of the optical scanning mirrors are illustrated as follows. (1) The torsional bars of the optical scanning mirror are flexible enough for lowering the driving voltage. (2) The mirror plates have enough stiffness for preventing the mirror plate from deformation. (3) The vertical comb electrodes have multiple depths. (4) Since the thin film is used as the substrate of the optical scanning mirror, there is enough space under the optical scanning mirror for facilitating the angular motion of the optical scanning mirror.

Accordingly, since the present invention provides optical microelectromechanical components and the fabrication method thereof for fabricating the polysilicon thin film with flexibility and thickened structure, the drawbacks in the prior art are overcome.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A method for fabricating an optical microelectromechanical component, comprising steps of:
(a) providing a substrate;
(b) depositing an oxide layer on said substrate as a first mask;
(c) performing a plurality of first etchings on said substrate to form a plurality of trenches with a plurality of depths;
(d) depositing a first polysilicon layer on said trenches to form refilled trenches.

2. The method according to claim 1, wherein said substrate is a silicon substrate.

3. The method according to claim 1, wherein said plurality of first etchings are first deep reactive ion etchings.

4. The method according to claim 1, wherein said plurality of first etchings are two first etchings.

5. The method according to claim 1, wherein said first polysilicon layer is removed by a second deep reactive ion etching.

6. The method according to claim 1, further comprising steps of:
(e) depositing a first nitride layer and a second polysilicon layer on said refilled trenches;
(f) removing said first polysilicon layer;
(g) depositing a second nitride layer; and
(h) performing a second etching.

7. The method according to claim 6, further comprising a step of (e1) patterning said first nitride layer and said second polysilicon layer to form an electrical connection.

8. The method according to claim 6, wherein said first nitride layer is a SixNy layer.

9. The method according to claim 6, wherein said oxide layer and said second nitride layer are performed as passivation layers.

10. The method according to claim 6, wherein said second nitride layer is a SixNy layer.

11. The method according to claim 6, further comprising a step of (g1) removing said oxide layer and said second nitride layer.

12. The method according to claim 11, wherein said oxide layer and said second nitride are removed by a hydrogen fluoride solution.

13. The method according to claim 6, wherein said second etching is a bulk etching.

14. The method according to claim 13, wherein said second nitride layer is a second mask for said bulk etching.

15. The method according to claim 13, wherein said bulk etching is performed in a tetra-methyl ammonium hydroxide (TMAH) solution.

16. A method for fabricating an optical microelectromechanical component, comprising steps of:
(a) providing a substrate;
(b) perfoming a first etching on said substrate to form at least one trench;
(c) depositing a polysilicon layer on said trench to form a refilled trench;
(d) depositing a nitride layer on said refilled trench; and
(e) performing a second etching.

17. The method according to claim 15, further comprising a step of (a1) depositing an oxide layer on said substrate as a self-aligned etching mask.

18. An optical microelectromechanical component fabricated by said method claimed in claim 1, comprising:
a polysilicon thin film substrate; and
a rib structure for strengthening said optical microelectromechanical component.

19. The optical microelectromechanical component according to claim 18, further comprising a torsional element for lowering a driving voltage and a plurality of electrodes with a plurality of depths.

20. The optical microelectromechanical component according to claim 19, wherein said optical microelectromechanical component is an optical scanner.
